(19) United States
(12) Patent Application Publication
(10) Pub. No.: US 2026/0221695 A1
(43) Pub. Date: Jul. 30, 2026

(54) CONNECTOR GROUND SHIELD TERMINAL WALLS

(71) Applicant: Molex, LLC, Lisle, IL (US)

(72) Inventors: David A. Burns, Brookfield, IL (US); Khang Choong Yong, Selangor (MY)

(21) Appl. No.: 19/457,365

(22) Filed: Jan. 23, 2026

Related U.S. Application Data
(60) Provisional application No. 63/749,717, filed on Jan. 27, 2025.
(60) Provisional application No. 63/928,504, filed on Dec. 1, 2025.

(51) Int. Cl. H01R 13/6581

(52) U.S. Cl. CPC H01R 13/6581

(57) ABSTRACT

Connectors with ground shield terminal walls and compliant shield pads are described. An example connector includes a housing with a slot for insertion of a board card edge interface and a wafer assembly positioned in the housing. The wafer assembly includes a channel shield and a pair of signal terminals that extend along a channel of the channel shield. The channel shield includes a channel floor wall, a pair of channel sidewalls, and a pair of ground shield terminal walls. Contact tip surfaces of the signal terminals and the ground shield terminal walls are configured to intersect a single contact tip plane, when the board card edge interface is inserted into the housing. Compliant shield pads are secured to the ground shield terminal walls, and a compliant ground strip is secured across the ground shield terminal walls. The shield pads and ground strip can be embodied as conductive foam.

### BACKGROUND

The amount of data processed by computers, computing systems, and computing environments continues to increase. Data centers, for example, can include hundreds of computing and networking systems interconnected using optical cables, copper cables, and a wide range of different connectors, cable assemblies, and terminations between them. The data throughput of these interconnect systems is high and increasing. As examples, many data centers incorporate a combination of 10 Gigabit Ethernet (10GbE), 25 GbE, 50 GbE, and 100 GbE network interfaces and interconnects. 200 GbE, 400 GbE, and 800 GbE interconnection technologies are also being developed and deployed. Other interconnection solutions rely upon 56 Gigabit per second (Gb/s), 112 Gb/s, and 224 Gb/s interconnection technologies, and interconnection technologies are being developed to support higher data rates. A range of cable assemblies and connectors are available for the data interconnects. A variety of different designs exist for the cable assemblies and connectors.

It can be particularly challenging to design connectors for high data rate applications and interconnection systems due to a number of competing concerns. High data rate interconnection systems often rely upon differentially coupled signal pairs in which two conductors are arranged in a pair to transmit a differential signal. The signal being transmitted is embodied by the electrical voltage/current difference measured between the two conductors. Differential signaling can be helpful to avoid or reject spurious signals and crosstalk and to avoid inadvertent signaling modes among adjacent signal pairs. In connector interfaces, ground terminals can be relied upon to create a current return path to electrical ground, provide shielding between differential pairs, and for other purposes.

Connectors used in high data rate applications are typically designed to meet a range of mechanical and electrical requirements. High data rate connectors are often used in front-panel input/output (I/O), backplane, and related applications that require very high conductor density and data rates. To achieve the desired mechanical and electrical requirements, the connectors used in such applications often incorporate one or more wafer assemblies. The wafer assemblies can include an insulative web that supports the signal and ground terminal conductors in the wafer assemblies. The use of wafer assemblies can be helpful to manufacture connectors capable of achieving high data rates using a number of different assembly processes. It is still challenging, in any case, to design connectors having the size and conductor density needed for new systems, while also maintaining the electrical characteristics needed for the data rates and signal integrity specified by emerging industry standards and customer specifications.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures. Various aspects and embodiments of connectors with ground shield terminal walls and compliant shield pads and strips are described herein. An example connector includes a housing with a slot for insertion of a board card edge interface and a wafer assembly positioned in the housing. The wafer assembly includes a channel shield and a pair of signal terminals that extend along a channel of the channel shield. The channel shield includes a channel floor wall, a pair of channel sidewalls, and a pair of ground shield terminal walls. The connector can also include a wafer molding insert that secures the pair of signal terminals to the channel shield and separates the pair of signal terminals from the channel shield in some cases.

Contact tip surfaces of the pair of signal terminals and of the pair of ground shield terminal walls are configured to intersect a single contact tip plane when the board card edge interface is inserted into the slot of the housing in one aspect of certain embodiments. The channel shield can also include a compliancy notch positioned between a ground shield terminal wall among the pair of ground shield terminal walls and a channel sidewall among the pair of channel sidewalls.

In other aspects, the channel shield comprises a channel floor wall and the pair of channel sidewalls. The channel of the channel shield extends between the pair of sidewalls and over the channel floor. The pair of ground shield terminal walls of the channel shield extend beyond an end edge of the channel floor wall.

In still other aspects, the connector can also include a compliant shield pad secured to a ground shield terminal wall among the pair of ground shield terminal walls. The compliant shield pad can be embodied as a conductive foam, fabric, or elastomer pad. The connector can also include a compliant ground strip secured across the pair of ground shield terminal walls. The compliant ground strip can be embodied as a conductive foam, fabric, or elastomer strip.

Another example connector includes a housing and a wafer assembly positioned in the housing. The wafer assembly includes a channel shield and a pair of signal terminals that extend along a channel of the channel shield. The channel shield includes a pair of ground shield terminal walls. Contact tip surfaces of the pair of signal terminals and of the pair of ground shield terminal walls are configured to intersect a single contact tip plane when a board card edge interface is inserted into the housing.

An example wafer assembly includes a channel shield and a pair of signal terminals that extend along a channel of the channel shield. The channel shield includes a channel floor wall, a pair of channel sidewalls, and a pair of ground shield terminal walls. Contact tip surfaces of the pair of signal terminals and of the pair of ground shield terminal walls are configured to intersect a single contact tip plane. The wafer assembly can also include a conductive compliant shield pad secured to a ground shield terminal wall among the pair of ground shield terminal walls in some cases. The wafer assembly can also include a conductive compliant ground strip secured across the pair of ground shield terminal walls in some cases.

Another example connector includes a housing and a wafer assembly positioned in the housing. The wafer assembly includes a channel shield, a signal terminal that extends along a channel of the channel shield, and a compliant shield pad. The channel shield includes a channel floor wall, a channel sidewall, and a ground shield terminal wall that extends from one end of the channel sidewall beyond an end edge of the channel floor wall. The ground shield terminal wall includes a pad notch that extends along a length of the ground shield terminal wall, and the compliant shield pad is secured in the pad notch of the ground shield terminal wall.

In other aspects, the ground shield terminal wall includes a tip contact and an angled edge at a distal end of the ground shield terminal wall. The pad notch extends between the end edge of the channel floor wall and the tip contact. The compliant shield pad is secured and electrically coupled to an upper notch edge of the pad notch. In one implementation, a thickness of the compliant shield pad is substantially equal to a distance between the upper notch edge and the tip contact of the ground shield terminal wall, measured orthogonally from the upper notch edge. In another implementation, a thickness of the compliant shield pad is less than a distance between the upper notch edge and the tip contact of the ground shield terminal wall, measured orthogonally from the upper notch edge.

An example connector interface includes a printed circuit board (PCB) having a board card edge interface and a connector. The board card edge interface includes a ground pad and a conductive snap actuator positioned over the ground pad. The connector includes a housing having a front port opening for insertion of the board card edge interface and a wafer assembly positioned in the housing. The wafer assembly includes a channel shield, a signal terminal that extends along a channel of the channel shield, and a compliant shield pad. The channel shield includes a channel floor wall, a channel sidewall, and a ground shield terminal wall that extends from one end of the channel sidewall beyond an end edge of the channel floor wall. The ground shield terminal wall includes a pad notch that extends along a length of the ground shield terminal wall, and the compliant shield pad is secured in the pad notch of the ground shield terminal wall.

In other aspects, before the board card edge interface is inserted into the front port opening of the connector, the ground shield terminal wall extends at a closed angle with respect to the channel floor wall. The ground shield terminal wall includes a tip contact and an angled edge at a distal end of the ground shield terminal wall. According to one aspect, when the board card edge interface is inserted into the front port opening of the connector, the tip contact of the ground shield terminal wall wipes up and over a top surface of the conductive snap actuator, and the ground shield terminal wall extends at an open angle with respect to the channel floor wall. In another aspect, when the board card edge interface is inserted into the front port opening of the connector, the tip contact of the ground shield terminal wall wipes up and over a top surface of the conductive snap actuator, and a clearance exists between the a top surface of the board card edge interface and a lower surface of the compliant shield pad. In still another aspect, when the board card edge interface is fully inserted into the front port opening of the connector, the tip contact of the ground shield terminal wall contacts the ground pad, and a lower surface of the compliant shield pad contacts an upper surface of the conductive snap actuator.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example connector according to various embodiments of the present disclosure.

FIG. 1B illustrates the connector shown in FIG. 1A, mounted to a circuit board and mated with a board card edge interface, according to various embodiments of the present disclosure.

FIG. 2A illustrates the wafer assemblies of the connector shown in FIG. 1A, with the housing of the connector omitted from view, according to various embodiments of the present disclosure.

FIG. 2B illustrates a wafer assembly of the connector shown in FIG. 1A, with parts expanded apart, according to various embodiments of the present disclosure.

FIG. 2C illustrates another wafer assembly of the connector shown in FIG. 1A, with parts expanded apart, according to various embodiments of the present disclosure.

FIG. 3A illustrates a top-down perspective view of two channel shields and compliant shield pads of the wafer assembly shown in FIG. 2A according to various embodiments of the present disclosure.

FIG. 3B illustrates a bottom-up perspective view of the two channel shields and compliant shield pads shown in FIG. 3A according to various embodiments of the present disclosure.

FIG. 4A illustrates a top-down perspective view of channel shields and terminal conductors of the wafer assembly shown in FIG. 2A according to various embodiments of the present disclosure.

FIG. 4B illustrates another top-down perspective view of channel shields and terminal conductors of the wafer assembly shown in FIG. 4A, with a card board edge interface inserted into the connector, according to various embodiments of the present disclosure.

FIG. 5A illustrates a side view of the channel shields and terminal conductors shown in FIG. 4A according to various embodiments of the present disclosure.

FIG. 5B illustrates a front view of the channel shields and terminal conductors shown in FIG. 5A according to various embodiments of the present disclosure.

FIG. 5C illustrates a back view of the channel shields and terminal conductors shown in FIG. 5A according to various embodiments of the present disclosure.

FIG. 6 illustrates a side view of ground shield terminal walls in the connector shown in FIG. 1A according to various embodiments of the present disclosure.

FIG. 7A illustrates a side view of another example channel shield, compliant shield pad, and board card edge interface according to various embodiments of the present disclosure.

FIGS. 7B-7D illustrate other arrangements of the channel shield, compliant shield pad, and board card edge interface shown in FIG. 7A according to various embodiments of the present disclosure.

FIG. 8A illustrates a side view of example channel shields, compliant shield pads, and a board card edge interface according to various embodiments of the present disclosure.

FIG. 8B illustrates another arrangement of the channel shields, compliant shield pads, and board card edge interface shown in FIG. 8A according to various embodiments of the present disclosure.

### DETAILED DESCRIPTION

The amount of data processed by computers, computing systems, and computing environments continues to increase. Data centers, for example, can include hundreds of computing and networking systems interconnected using optical cables, copper cables, and a wide range of different connectors, cable assemblies, and terminations between them.

The small form-factor pluggable (SFP) module format is a compact, hot-pluggable network interface module format used for data interconnects, and SFP modules are commonly used for interconnects in data centers. An SFP interface on a computing or networking system is a modular slot for a media-specific transceiver, such as a copper or fiber-optic cable assembly. Cable assemblies can include SFP transceiver modules at one or both ends of a copper, fiber-optic, or other type of interconnecting cable. SFP transceiver modules can be inserted into SFP interfaces for data interconnections.

A range of SFP transceiver modules are currently available, such as small form-factor pluggable double density (SFP-DD), compact small form-factor pluggable (cSFP), SFP+, quad small form-factor pluggable (QSFP), quad small form-factor pluggable double density (QSFP-DD), octal small form factor pluggable (OSFP), and others. An active electrical cable (AEC) assembly can include an SFP transceiver module at the free end of cables or a cable bundle. An AEC assembly can include more printed circuit boards (PCBs) and semiconductor chips for signal re-timing, noise reduction, signal integrity improvement, and other functions. SFP transceiver modules often include one or more PCBs with semiconductor circuit devices or chips and other circuitry mounted to the PCBs. The PCBs can provide PCB-style tip interfaces at one end or side of the module, for insertion into a mating connector.

Connectors are often designed to meet a range of different electrical and mechanical requirements or specifications. Many connectors incorporate one or more wafer assemblies that are carefully designed to meet or exceed industry standard or related specifications. The use of wafer assemblies can be helpful to manufacture connectors capable of high data rates using a range of different assembly processes. It is still challenging, in any case, to design connectors having the size and conductor density needed for new systems, while also maintaining the electrical characteristics needed for the data rates and signal integrity specified by emerging industry standards and customer specifications.

In the context outlined above, various aspects and embodiments of connectors with ground shield terminal walls and compliant shield pads are described herein. An example connector includes a housing with a slot for insertion of a board card edge interface and a wafer assembly positioned in the housing. The wafer assembly includes a channel shield and a pair of signal terminals that extend along a channel of the channel shield. The channel shield includes a channel floor wall, a pair of channel sidewalls, and a pair of ground shield terminal walls. Contact tip surfaces of the signal terminals and the ground shield terminal walls are configured to intersect a single contact tip plane, when the board card edge interface is inserted into the housing. Compliant shield pads are secured to the ground shield terminal walls, and a compliant ground strip is secured across the ground shield terminal walls. The compliant shield pads and ground strip can be embodied as conductive foam, fabric, or elastomer in some embodiments. The ground shield terminal walls, compliant shield pads, compliant ground strips, and other features of the connectors described herein help to improve EMI shielding in, control signal integrity performance in, and allow for increased data rates through the connectors.

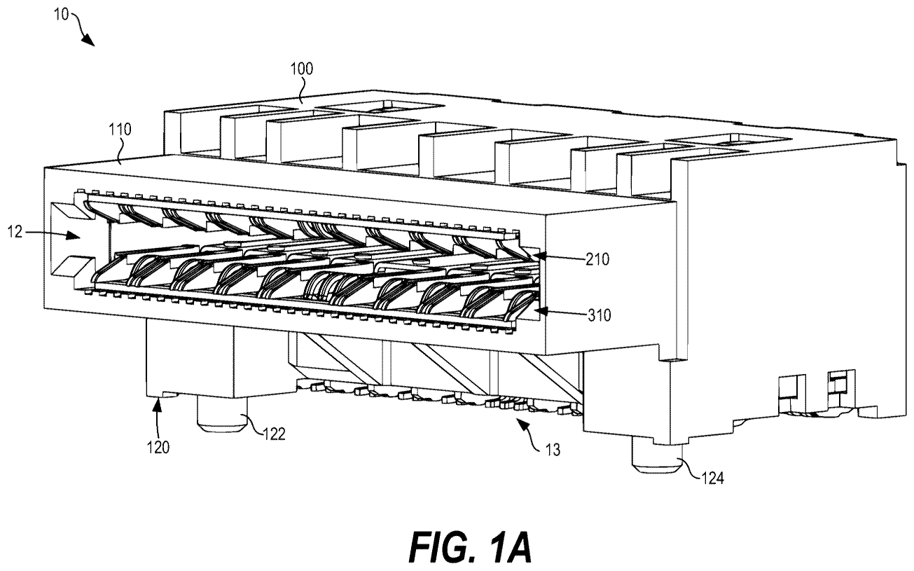

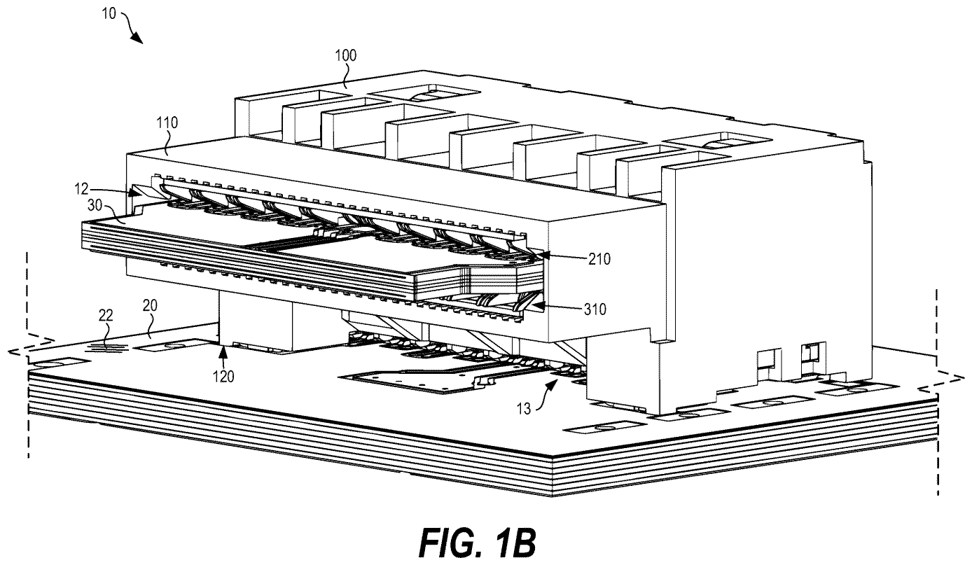

Turning to the drawings, FIG. 1A illustrates a perspective view of an example connector 10 according to various embodiments of the present disclosure. The connector 10 is illustrated as a representative example of a connector including ground shield terminal walls and compliant shield pads. The concepts described herein can be extended to use with a range of connectors of different types, styles, and formats, however. The connector 10 is not drawn to any particular scale or size in the drawings. The shape, size, proportion, and other characteristics of the connector 10 can vary as compared to that shown. For example, the connector 10 can accommodate larger or smaller rows of terminal conductors (e.g., be wider or narrower), and other variations are within the scope of the examples described herein. A number of connectors similar to the connector 10 can be stacked or arranged side-by-side, for higher data rate interconnection systems. Additionally, one or more of the parts or components of the connector 10, as illustrated in the drawings and described herein, can be omitted in some cases. The connector 10 can also include other parts or components that are not illustrated.

The connector 10 includes a front port opening 12 and a terminal foot 13. The connector 10 is designed to establish and maintain electrical connections with contact pads on opposing sides of a board card edge interface. As one example, the PCB-style tip of a transceiver module, such as an SFP transceiver module, can be inserted into the front port opening 12 of the connector 10. The connector 10 includes two (2) rows of signal terminal conductors and ground shield terminal walls. The terminal conductors and ground shield walls are supported by wafer assemblies of the connector 10, as described in additional detail below. The terminal conductors and ground shield walls extend from the front port opening 12 to the terminal foot 13 of the connector 10, for the communication of data signals through the connector 10.

The connector 10 is designed to provide shielding and maintain the signal integrity of differential signals that are transmitted over the signal terminal conductors within the connector 10, as they extend from the front port opening 12 to the terminal foot 13. The connector 10 can be designed as a mating connector for use with SFP or related interconnection systems, as one example, although the connector 10 can be mated with other types of board card edge interconnection systems. The concepts described herein are also not limited to use with any particular type or style of interconnection system. The terminal foot 13 of the connector 10 can be designed as a surface mount technology (SMT) foot, for coupling to the surface of a PCB, but the connector 10 can also be designed to have through-hole or other lead styles of terminal conductors at the terminal foot 13. The connector 10 is shown mounted to a PCB in FIG. 1B. The concepts described herein can also be extended to connectors that incorporate bypass cables, and certain signal and ground terminal conductors of the connector 10 can be directly coupled to one or more twinax cables in some cases, for signal bypass applications.

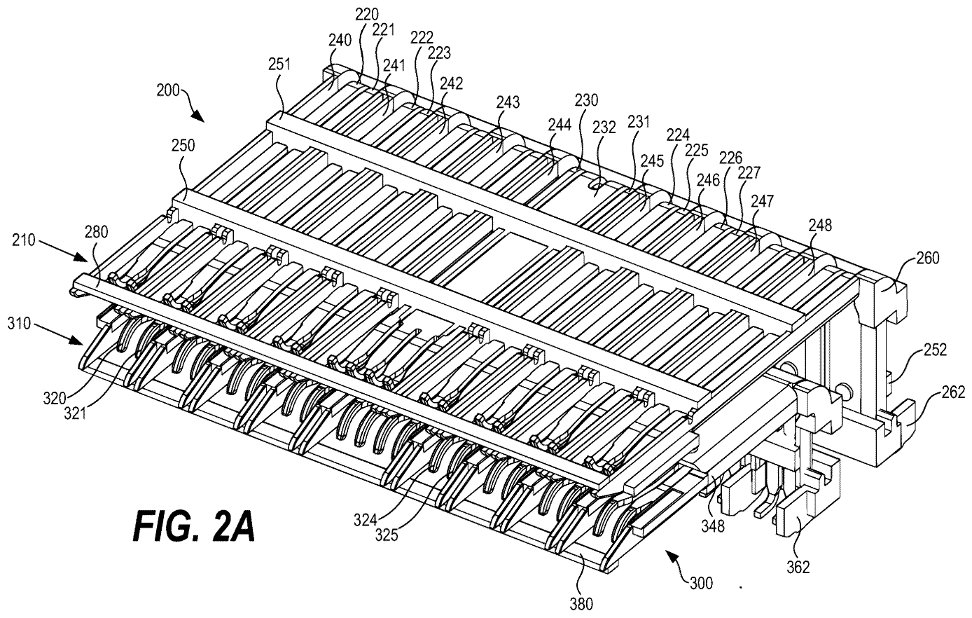

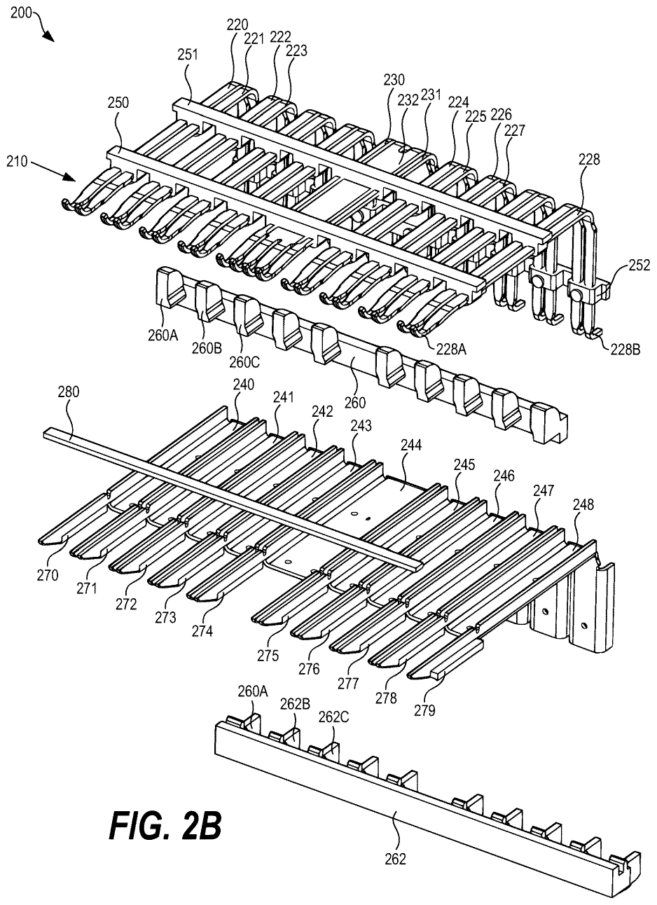

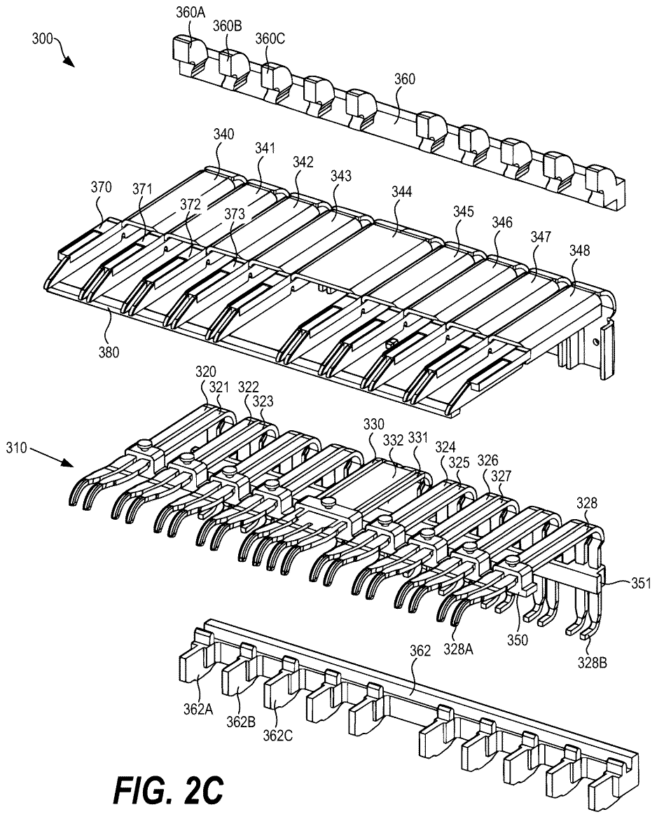

As shown in FIG. 1A, the connector 10 includes a housing 100 and rows 210 and 310 of terminal conductors and ground shield terminal walls having contact tips located at and within the opening 12. The connector 10 includes an upper wafer assembly that is positioned and secured within the housing 100 and a lower wafer assembly that is positioned and secured within the housing 100. The wafer assemblies are described in further detail below with reference to FIGS. 2A and 2B. The row 210 is provided by the upper wafer assembly, and the row 310 is provided by the lower wafer assembly, as also described below.

The housing 100 can be formed from a plastic, polymer, or other insulating material, such as liquid crystal polymer (LCP), polyethylene (PE), polytetrafluoroethylene (PTFE), fluoropolymer, or other plastic or insulating material(s). The housing 100 can also be formed from metal or combinations of insulating and conductive materials in some cases. The housing 100 can be formed using any suitable additive or subtractive manufacturing techniques, including molding, injection molding, printing, and other techniques.

The housing 100 include a front port 110, a bottom mounting surface 120, and mounting posts 122 and 124, among other features. The connector 10 can be configured to receive the PCB-style tip of an SFP transceiver module, as one example, although the connector 10 can also receive other types of board card edge interfaces. When the PCB-style tip is inserted into the front port opening 12, the rows 210 and 310 of signal terminal conductors and ground shield terminal walls will contact, wipe against, and make electrical contact with contact pads on the top and bottom surfaces of the PCB-style tip.

The shielding for the signal terminal conductors in the rows 210 and 310 can be particularly important for the connector 10. Suitable electromagnetic interference (EMI) shielding can be necessary to meet the electrical characteristic and signal integrity specifications of emerging industry standards, as one example among other reasons. EMI shielding is important throughout the connector 10, including within the front port opening 12, at the terminal foot 13, and inside the body of the housing 100 between the opening 12 and the foot 13.

The connector 10 includes a number of channel shields having ground shield terminal walls. The ground shield terminal walls are used in place of ground terminal conductors, as commonly used in other connectors, in the connector 10. Each pair of signal terminal conductors in the rows 210 and 310 extends along and within a channel shield, between the front port opening 12 and the terminal foot 13 of the connector 10. At one end of a channel shield, the sidewalls of the channel shield are formed as extended ground shield terminal walls. At the other end of the channel shield, the sidewalls of the channel shield are formed to include ground contact tips. The ground shield terminal walls are relatively larger in certain dimensions than the signal terminal conductors, and two ground shield terminal walls are positioned on opposite sides of each pair of signal terminal conductors. Compliant shield pads, such as conductive foam/elastomer pads, are also attached to the ground shield terminal walls. The ground shield terminal walls and compliant shield pads substantially surround each pair of signal terminal conductors in the connector 10, particularly when a PCB-style tip interface is inserted and fully seated into the front port opening 12 of the connector 10.

FIG. 1B illustrates the connector 10 shown in FIG. 1A, mounted to a PCB 20 and mated with a board card edge interface 30. The bottom mounting surface 120 of the connector 10 is seated upon the top surface 22 of the PCB 20. Although not visible in FIG. 1B, the mounting posts 122 and 124 of the connector 10 are inserted into apertures through the PCB 20, which helps to secure the connector 10 in place with respect to the PCB 20. The tail ends of the signal terminal conductors and the ground shield terminal walls in the rows 210 and 310 can be electrically coupled to contact pads on the top surface of the PCB 20 using solder, conductive adhesives, welds, or other means at the terminal foot 13 of the connector 10. In that way, differential data signals, for example, transmitted on the signal terminal conductors of the connector 10 can be electrically coupled to the PCB 20 and traces extending on and through the PCB 20.

FIG. 1B also illustrates the board card edge interface 30 inserted into the front port opening 12 of the connector 10. The board card edge interface 30 is representative of a PCB-style tip of an SFP module, although other types of board card edge interfaces can be inserted into the front port opening 12. When the board card edge interface 30 is inserted into the front port opening 12, the rows 210 and 310 of signal terminal conductors and ground shield terminal wipe against and make electrical contact with the contact pads on the top and bottom surfaces of the board card edge interface 30. As discussed above, the shielding for the signal terminal conductors in the rows 210 and 310 can be particularly important for the connector 10. EMI shielding is important throughout the connector 10, including within the front port opening 12, at the terminal foot 13, and inside the body of the housing 100 between the opening 12 and the foot 13. The connector 10 includes channel shields having ground shield terminal walls. Compliant shield pads are also attached to the ground shield terminal walls. The ground shield terminal walls and compliant shield pads substantially surround each pair of signal terminal conductors in the connector 10 and form EMI shield pockets over the top and bottom surfaces of the board card edge interface 30. These and other aspects of the embodiments are described in further detail below.

FIG. 2A illustrates wafer assemblies 200 and 300 of the connector 10 shown in FIG. 1A, with the housing 100 of the connector 10 omitted from view. FIG. 2B illustrates parts of the wafer assembly 200 expanded apart from each other, and FIG. 2C illustrates parts of the wafer assembly 300 expanded apart from each other. The wafer assembly 200 can be referred to as an upper wafer assembly in the connector 10, and the wafer assembly 300 can be referred to as a lower wafer assembly in the connector 10. The wafer assemblies 200 and 300 include terminal conductors (e.g., signal terminal conductors) for the communication of high-speed data signals, low-speed data signals, and power through the connector 10. The terminal conductors of the wafer assembly 200 can transfer data from the front port opening 12 to the terminal foot 13 of the connector 10 (e.g., be used for data reception), and the wafer assembly 300 can transfer data from the terminal foot 13 to the front port opening 12 of the connector 10 (e.g., be used for data transmission). However, the wafer assemblies 200 and 300 and the pairs of signal terminal conductors in the wafer assemblies 200 and 300 are not limited to any particular direction of data transfer and can be used in any combination of data reception and transmission, between the front port opening 12 to the terminal foot 13 of the connector 10, among the embodiments.

Referring among FIGS. 2A and 2B, the wafer assembly 200 includes signal terminal conductors 220-228, 230, and 231 (also “signal terminals 220-228, 230, and 231”), among others, a power terminal conductor 232 (also “power terminal 232,” and collectively “terminals 220-228 and 230-232”), channel shields 240-248, wafer molding inserts 250-252, shielding inserts 260 and 262, compliant shield pads 270-279, and a compliant ground strip 280. The wafer assembly 200 is illustrated as a representative example in FIG. 2A, and the size, number, shape, and other aspects of the components of the wafer assembly 200 can vary as compared to that shown.

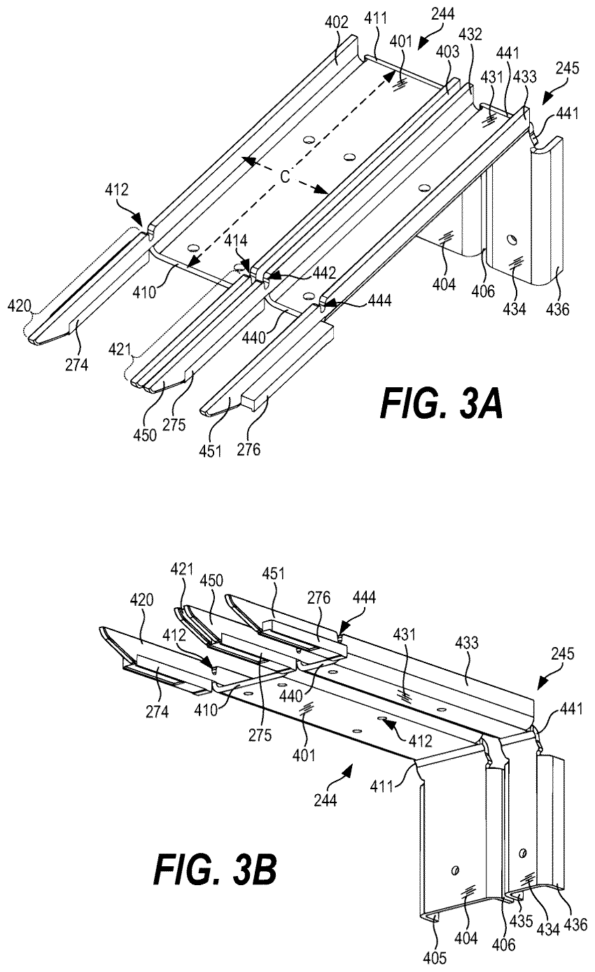

The terminals 220-228 and 230-232 can be formed (e.g., stamped, sheared, bent, and otherwise formed) from a flat sheet of metal or other conductive material. In some cases, the sheet of metal can be plated with one or more plating metals. Each of the channel shields 240-248 can also be formed (e.g., stamped, sheared, or otherwise formed) from a flat sheet of metal or other conductive material, which can be plated in some cases. Each of the channel shields 240-248 is bent or pressed into type of “U” or channel shape and includes a pair of ground shield terminal walls, as described in further detail below with reference to FIGS. 3A and 3B.

The terminals 220-228 and 230-232 can be formed (e.g., stamped, sheared, bent, and otherwise formed) in a row, alongside each other, and at the same time from a single sheet of metal, in one example. Each of the terminals 220-228 and 230-232 includes a lead or tip contact at one distal end (i.e., positioned in the front port opening 12 of the connector 10, as shown in FIG. 1A), a tail contact at another distal end (i.e., positioned at the terminal foot 13), and a terminal conductor body and bend between the top contact and the tail contact. For example, as shown in FIG. 2B, the signal terminal conductor 228 includes a tip contact 228A and a tail contact 228B. The tail contacts of the terminals 220-228 and 230-232 can be formed as SMT tail contacts, as in the example shown, or as through-hole (e.g., eye-of-needle) or other types of tail contacts.

The signal terminal conductors 220-228, among others in the wafer assembly 200, can be arranged and used in pairs of terminal conductors to transfer high-speed differential signals. For example, the conductors 220 and 221 can be relied upon as a first pair of signal terminal conductors for communicating a first high-speed differential signal, the conductors 222 and 223 can be relied upon as a second pair of signal terminal conductors for communicating a second high-speed differential signal, the conductors 224 and 225 can be relied upon as a third pair of signal terminal conductors for communicating a third high-speed differential signal, and so on. The signal terminal conductors 230 and 231, among possibly others in the wafer assembly 200, can be relied upon as a pair of signal terminal conductors for communicating a first low-speed differential signal. The power terminal conductor 232 can be relied upon to source or sink power, for example, such as for sinking or sourcing a direct current (DC) supply of power at 5V, 12V, or another potential.

The channel shields 240-248 form part of a shielding and grounding network for the signal terminals in the connector 10. Thus, the signal terminal conductors 220-228, 230, and 231, the power terminal conductor 232, and other terminal conductors of the wafer assembly 200 can be arranged with the channel shields 240-248, as shown in FIG. 2A. The terminals 220-228 and 230-231 extend along and within the channels of the channel shields 240-248 in the wafer assembly 200. As shown in FIG. 2A, the pair of signal terminal conductors 220 and 221 can be positioned to extend within the channel of the channel shield 240. In that arrangement, the channel shield 240 provides EMI shielding for the signal terminal conductors 220 and 221 and helps to reduce crosstalk and spurious signals between the signal terminal conductors 220 and 221 and other terminal conductors in the connector 10. Similarly, the pair of signal terminal conductors 222 and 223 can be positioned to extend within the channel of the channel shield 241, the pair of signal terminal conductors 224 and 225 can be positioned to extend within the channel of the channel shield 245, and so on. At the middle of the wafer assembly 200, the signal terminal conductors 230 and 231 and the power terminal conductor 232 can be positioned to extend within the channel of the channel shield 244, which is be wider than the other channel shields.

The wafer molding inserts 250-252 can be formed by injection molding. In one example, the terminal conductors 220-228 and 230-232, among others in the row 210, can be arranged and positioned in a mold along with the channel shields 240-248. The wafer molding inserts 250-252 can then be formed by the injection of a plastic, such as LCP or another insulating material(s), into the mold. The insulating material can flow around the terminal conductors 220-228 and 230-232 within the mold, to form the wafer molding inserts 250-252 at the locations shown in FIG. 2B.

The wafer molding inserts 250-252 serve a number of purposes in the wafer assembly 200. The wafer molding inserts 250-252 secure the terminal conductors 220-228 and 230-232 in place relative to each other. The wafer molding inserts 250-252 also electrically isolate the terminal conductors 220-228 and 230-232 from each other. When formed, the insulating material of the wafer molding inserts 250-252 can also flow through, or otherwise be inserted through, openings or apertures in the channel shields 240-248, and a heat staking process can be used to form staking caps of the wafer molding inserts 250-252. The staking caps secure the wafer molding inserts 250-252 with the channel shields 240-248, as described in further detail below. Thus, when formed, the wafer molding inserts 250-252 secure the terminal conductors 220-228 and 230-232 to the channel shields 240-248, electrically isolate the terminal conductors 220-228 and 230-232 from each other, and electrically isolate the terminal conductors 220-228 and 230-232 from the channel shields 240-248.

The shielding inserts 260 and 262 can be separately formed from a plastic or polymer, such as LCP, PE, PTFE, fluoropolymer, or other plastic or insulating material(s) and assembled to the channel shields 240-248. The shielding insert 260 can be secured between the channel shields 240-248 at the location where each of the channel shields 240-248 includes a bend, as also described below. The shielding insert 260 can be secured between the channel shields 240-248 using a press-or interference-fit, for example, and adhesives, mechanical fasteners, mechanical interlocks, and other fastening means can be used to secure the shielding insert 260 to the channel shields 240-248 in some cases. The shielding insert 262 can be secured between the channel shields 240-248 at one end of the channel shields 240-248, as also described below. The shielding insert 262 can form part of the terminal foot 13 (see FIG. 1A) of the connector 10 and provide EMI shielding at the terminal foot 13.

The shielding insert 260 includes a number of corner bumpers, such as the corner bumpers 260A-260C, among others, in the example shown. The corner bumpers 260A-260C fit beside or between the channel shields 240-242, at the corners of the channel shields 240-242. The corner bumpers 260A-260C occupy openings in between the sidewalls of the channel shields 240-242, at the corners of the channel shields 240-242, and help to improve EMI shielding. Other corner bumpers of the shielding insert 260 can also occupy other openings at corners of other channel shields in the wafer assembly 200. The shielding insert 262 includes a number of tail bumpers, such as the tail bumpers 262A-262C, among others. The tail bumpers 262A-262C fit beside or between the channel shields 240-242 at the tail ends of the channel shields 240-242. The tail bumpers 262A-262C, among others, provide additional shielding at the tail ends of the terminal conductors 220-228 and 230-232, among others in the row 210, at the terminal foot 13 of the connector 10.

The shielding inserts 260 and 262 can be formed using any suitable additive or subtractive manufacturing techniques, including molding, injection molding, printing, and other techniques. Outer surfaces of the shielding inserts 260 and 262 can be selectively metalized or plated with a plating metal or metals for conductivity in some cases, and the shielding inserts 260 and 262 can be embodied as plated plastic components. In one example, all exterior-facing outer surfaces of the shielding inserts 260 and 262 are plated with a metal or metals for conductivity. In other cases, only certain surfaces or surface regions of the shielding inserts 260 and 262 are plated. The plating facilitates the use of the shielding inserts 260 and 262 as a common ground or drain connection in the wafer assembly 200, as well as a type of EMI shield.

When formed from a plastic or polymer, surfaces or surface regions of the shielding inserts 260 and 262 can be etched in some cases and metalized or plated in a bath, barrel plated, plated by physical vapor deposition (PVD), plated by electroless plating, electroplating, sputter plating, ion plating, or other plating techniques or a combination thereof. The surfaces of the shielding inserts 260 and 262 can be metalized or plated with copper, nickel, tin, silver, other plating metals, or combinations of plating metals. In another metallization approach, the material from which the shielding inserts 260 and 262 are formed can include a laser direct structuring (LDS) additive. A laser beam can be used to activate the LDS additive over certain surfaces or surface areas of the shielding inserts 260 and 262 for metallization. A subsequent metallization process can be performed by submerging the shielding inserts 260 and 262 in a bath, and conductive metal plating can adhere to the activated surfaces or surface areas of the shielding inserts 260 and 262. A number of different layers of metal, such as copper, nickel, tin, gold, or other plating metals or combinations thereof can be successively plated in that approach. Thus, the shielding inserts 260 and 262 can also form part of the shielding and grounding network for the signal terminals in the connector 10. Because the shielding inserts 260 and 262 can be plated and conductive, the shielding inserts 260 and 262 can electrically couple (i.e., electrically “common”) potentials among the channel shields 240-248. In other cases, the shielding inserts 260 and 262 can be formed using a die-cast, molding, or related approach using a conductive material, such as a metal, metal alloy, or other conductive material.

The compliant shield pads 270-279 can be embodied as a type of elastic, expandible, and compressible material. The compliant ground strip 280 can also be embodied as a type of elastic, expandible, and compressible material. The compliant shield pads 270-279 and the compliant ground strip 280 can also be conductive, in addition to being expandible and compressible. As one example, the compliant shield pads 270-279 and/or the compliant ground strip 280 can be embodied as a polyurethane foam multi-laminate including conductive materials, such as copper, nickel, or other conductive metals or materials. The compliant shield pads 270-279 and/or the compliant ground strip 280 can be embodied as the P-SHIELD® brand PS-1323, PS-1768, or similar conductive foam, foam tape, or foam sheet manufactured by Polymer Science, Inc. of Monticello, Indiana, although other suitable types of conductive elastomeric or foam materials can be relied upon. As another example, the compliant shield pads 270-279 and/or the compliant ground strip 280 can be embodied as a hyper-elastic material, such as silicone doped with conductive media, including the CHO-SEAL 1215 material of Parker Hannifin Corporation.

In some cases, a first subset of the compliant shield pads 270-279 can be embodied as a first conductive foam, such as the PS-1323 conductive foam, and a second subset of the compliant shield pads 270-279 can be embodied as a second conductive foam, such as the PS-1768 conductive foam. Thus, each of the compliant shield pads 270-279 can be embodied or formed from the same type of conductive, compressible material in some cases. In other cases, two or more of the compliant shield pads 270-279 can be formed from different types of materials.

The compliant shield pads 270-279 are secured, adhered, or otherwise attached to the channel shields 240-248. More particularly, the compliant shield pads 270-279 are secured to the ground shield terminal walls of the channel shields 240-248. Several of the compliant shield pads 270-279 contact and are adhered to two (2) of the channel shields 240-248. As one example, the compliant shield pad 276 contacts and is adhered to ground shield terminal walls of the channel shields 244 and 245. Thus, the compliant shield pad 276 spans across and is adhered to two different ground shield terminal walls of two different channel shields 244 and 245 in at least one example. A compliant shield pad that spans across ground shield terminal walls of two different channel shields can help to electrically common potentials among the channel shields. In other cases, channel shield pads can be adhered to only one ground shield terminal wall of one channel shield, and the wafer assembly 200 can also include a one-to-one correspondence between compliant shield pads and ground shield terminal walls in some cases. The wafer assembly 200 can also include a combination of compliant shield pads that span across two different ground shield terminal walls of two different channel shields and other compliant shield pads that are adhered to only a single ground shield terminal wall of one channel shield. The compliant shield pads 270-279 can be secured or otherwise attached to the channel shields 240-248 using adhesives, hot melting or welding, mechanical interferences or interlocking features, or using other means or approaches. The compliant shield pads 270-279 and other conductive compliant shielding materials described herein can also be molded onto or over-molded over surfaces and edges of the channel shields and ground shield terminal walls in other approaches.

The compliant ground strip 280 extends laterally across each of the channel shields 240-248, at a position toward the tip ends of the ground shield terminal walls of the channel shields 240-248, as best shown in the example of FIG. 2A. The compliant ground strip 280 can also be located laterally across the channel shields 240-248, or partly across a subset of the channel shields 240-248, at other locations or positions. The wafer assembly 200 can also include more than one compliant ground strip, such as two or more compliant ground strips that extend across one or more of the channel shields 240-248 at one or more locations or positions. The compliant ground strip 280 can be secured or otherwise attached across the channel shields 240-248 using adhesives, hot melting or welding, mechanical interferences or interlocking features, or using other means or approaches. The compliant shield pads 270-279 and the compliant ground strip 280 also form part of the shielding and grounding network in the connector 10. The compliant shield pads 270-279 and the compliant ground strip 280 are conductive and can electrically couple (i.e., electrically “common”) potentials among the channel shields 240-248. Additional aspects of the compliant shield pads 270-279 and the compliant ground strip 280 are described below.

Referring among FIGS. 2A and 2C, the wafer assembly 300 includes signal terminal conductors 320-328, 330, and 331 (also “signal terminals 320-328, 330, and 331”), among others, a power terminal conductor 332 (also “power terminal 332,” and collectively “terminals 320-328 and 330-332”), channel shields 340-348, wafer molding inserts 350-351, shielding inserts 360 and 363, compliant shield pads 370-373, and a compliant ground strip 380. The wafer assembly 300 is illustrated as a representative example in FIG. 2A, and the size, number, shape, and other aspects of the components of the wafer assembly 300 can vary as compared to that shown.

The terminals 320-328 and 330-332 can be formed (e.g., stamped, sheared, bent, and otherwise formed) from a flat sheet of metal or other conductive material. In some cases, the sheet of metal can be plated with one or more plating metals. Each of the channel shields 340-348 can also be formed (e.g., stamped, sheared, or otherwise formed) from a flat sheet of metal or other conductive material, which can be plated in some cases. Each of the channel shields 340-348 is bent or pressed into type of “U” or channel shape and includes a pair of ground shield terminal walls, as described in further detail below with reference to FIGS. 3A and 3B.

The terminals 320-328 and 330-332 can be formed (e.g., stamped, sheared, bent, and otherwise formed) in a row, alongside each other, and at the same time from a single sheet of metal, in one example. Each of the terminals 320-328 and 330-332 includes a lead or tip contact at one distal end (i.e., positioned in the front port opening 12 of the connector 10, as shown in FIG. 1A), a tail contact at another distal end (i.e., positioned at the terminal foot 13), and a terminal conductor body and bend between the top contact and the tail contact. For example, as shown in FIG. 2C, the signal terminal conductor 328 includes a tip contact 328A and a tail contact 328B. The tail contacts of the terminals 320-328 and 330-332 can be formed as SMT tail contacts, as in the example shown, or as through-hole (e.g., eye-of-needle) or other types of tail contacts.

The signal terminal conductors 320-328, among others in the wafer assembly 300, can be arranged and used in pairs of terminal conductors to transfer high-speed differential signals. For example, the conductors 320 and 321 can be relied upon as a fourth pair of signal terminal conductors for communicating a fourth high-speed differential signal, the conductors 322 and 323 can be relied upon as a fifth pair of signal terminal conductors for communicating a fifth high-speed differential signal, the conductors 324 and 325 can be relied upon as a sixth pair of signal terminal conductors for communicating a sixth high-speed differential signal, and so on. The signal terminal conductors 330 and 331, among possibly others in the wafer assembly 300, can be relied upon as a pair of signal terminal conductors for communicating a second low-speed differential signal. The power terminal conductor 332 can be relied upon to source or sink power, for example, such as for sinking or sourcing a DC supply of power at 5V, 12V, or another potential.

The channel shields 340-348 form part of the shielding and grounding network for the signal terminals in the connector 10. Thus, the signal terminal conductors 320-328, 330, and 331, the power terminal conductor 332, and other terminal conductors of the wafer assembly 300 can be arranged with the channel shields 340-348. The terminals 320-328 and 330-332 extend along and within the channels of the channel shields 340-348 in the wafer assembly 300. The pair of signal terminal conductors 320 and 321, for example, can be positioned to extend within the channel of the channel shield 340. In that arrangement, the channel shield 340 provides EMI shielding for the signal terminal conductors 320 and 321 and helps to reduce crosstalk and spurious signals between the signal terminal conductors 320 and 321 and other terminal conductors in the connector 10. Similarly, the pair of signal terminal conductors 322 and 323 can be positioned to extend within the channel of the channel shield 341, the pair of signal terminal conductors 324 and 325 can be positioned to extend within the channel of the channel shield 345, and so on. At the middle of the wafer assembly 300, the signal terminal conductors 330 and 331 and the power terminal conductor 332 can be positioned to extend within the channel of the channel shield 344, which is wider than the other channel shields.

The wafer molding inserts 350 and 351 can be formed by injection molding. In one example, the terminal conductors 320-328 and 330-332, among others in the row 310, can be arranged and positioned in a mold along with the channel shields 340-348. The wafer molding inserts 350 and 351 can then be formed by the injection of a plastic, such as LCP or another insulating material(s), into the mold. The insulating material can flow around the terminal conductors 320-328 and 330-332 within the mold, to form the wafer molding inserts 350 and 351.

The wafer molding inserts 350 and 351 serve a number of purposes in the wafer assembly 300. The wafer molding inserts 350 and 351 secure the terminal conductors 320-328 and 330-332 in place relative to each other. The wafer molding inserts 350 and 351 also electrically isolate the terminal conductors 320-328 and 330-332 from each other. When formed, the insulating material of the wafer molding inserts 350 and 351 can also flow through, or otherwise be inserted through, openings or apertures in the channel shields 340-348, and a heat staking process can be used to form staking caps of the wafer molding inserts 350 and 351. The staking caps secure the wafer molding inserts 350 and 351 with the channel shields 340-348, as described in further detail below. Thus, when formed, the wafer molding inserts 350 and 351 secure the terminal conductors 320-328 and 330-332 to the channel shields 340-348, electrically isolate the terminal conductors 320-328 and 330-332 from each other, and electrically isolate the terminal conductors 320-328 and 330-332 from the channel shields 340-348.

The shielding inserts 360 and 362 can be separately formed from a plastic or polymer, such as LCP, PE, PTFE, fluoropolymer, or other plastic or insulating material(s) and assembled to the channel shields 340-348. The shielding insert 360 can be secured between the channel shields 340-348 at the location where each of the channel shields 340-348 includes a bend, as also described below. The shielding insert 360 can be secured between the channel shields 340-348 using a press-or interference-fit, for example, and adhesives, mechanical fasteners, mechanical interlocks, and other fastening means can be used to secure the shielding insert 360 to the channel shields 340-348 in some cases. The shielding insert 362 can be secured between the channel shields 340-348 at one end of the channel shields 340-348, as also described below. The shielding insert 362 can form part of the terminal foot 13 (see FIG. 1A) of the connector 10 and provide EMI shielding at the terminal foot 13.

The shielding insert 360 includes a number of corner bumpers, such as the corner bumpers 360A-360C, among others, in the example shown. The corner bumpers 360A-360C fit beside or between the channel shields 340-348 at the corners of the channel shields 340-342. The corner bumpers 360A-360C occupy the openings in between the sidewalls of the channel shields 340-342, at the corners of the channel shields 340-342, and help to improve EMI shielding. Other corner bumpers of the shielding insert 360 can also occupy other openings at corners of other channel shields in the wafer assembly 300. The shielding insert 362 includes a number of tail bumpers, such as the tail bumpers 362A-362C, among others. The tail bumpers 362A-362C fit between the channel shields 340-342 at the tail ends of the channel shields 340-342. The tail bumpers 362A-362C, among others, provide shielding at the tail ends of the terminal conductors 320-328 and 330-332, among others in the row 310, at the terminal foot 13 of the connector 10.

The shielding inserts 360 and 362 can be formed using any suitable additive or subtractive manufacturing techniques, including molding, injection molding, printing, and other techniques. Similar to the shielding inserts 260 and 262 of the wafer assembly 200, the outer surfaces of the shielding inserts 360 and 362 of the wafer assembly 300 can be selectively metalized or plated with a plating metal or metals for conductivity in some cases. In one example, all exterior-facing outer surfaces of the shielding inserts 360 and 362 are plated with a metal or metals for conductivity. In other cases, only certain surfaces or surface regions of the shielding inserts 360 and 362 are plated. The plating facilitates the use of the shielding inserts 360 and 362 as a common ground or drain connection in the wafer assembly 300, as well as a type of EMI shield. In other cases, the shielding inserts 360 and 362 can be formed using a die-cast, molding, or related approach using a conductive material, such as a metal, metal alloy, or other conductive material.

The compliant shield pads 370-373, among others in the wafer assembly 300, can be embodied as a type of elastic, expandible, and compressible material. The compliant ground strip 380 can also be embodied as a type of elastic, expandible, and compressible material. The compliant shield pads 370-373 and the compliant ground strip 380 can also be conductive, in addition to being expandible and compressible. As one example, the compliant shield pads 370-373 and/or the compliant ground strip 380 can be embodied as a polyurethane foam multi-laminate including conductive materials, such as copper, nickel, or other conductive metals or materials. The compliant shield pads 370-373 and the compliant ground strip 380 can be embodied as the P-SHIELD® brand PS-1332, PS-1768, or similar conductive foam, foam tape, or foam sheet, although other suitable types of conductive elastomeric or foam materials can be relied upon. As another example, the compliant shield pads 370-373 and/or the compliant ground strip 380 can be embodied as a hyper-elastic material, such as silicone doped with conductive media, including the CHO-SEAL 1215 material of Parker Hannifin Corporation.

In some cases, a first subset of the compliant shield pads 370-373 can be embodied as a first conductive foam, such as the PS-1332 conductive foam, and a second subset of the compliant shield pads 370-373 can be embodied as a second conductive foam, such as the PS-1768 conductive foam. Thus, each of the compliant shield pads 370-373, among others, can be embodied or formed from the same type of conductive, compressible material in some cases. In other cases, two or more of the compliant shield pads 370-373 can be formed from different types of materials.

The compliant shield pads 370-373 are secured, adhered, or otherwise attached to the channel shields 340-343, and additional compliant shield pads are secured to the other channel shields 344-348 in the wafer assembly 300. More particularly, the compliant shield pads 370-373 are secured to the ground shield terminal walls of the channel shields 340-343. Several of the compliant shield pads 370-373, among others in the wafer assembly 300, contact and are adhered to two (2) of the channel shields 340-348. As one example, the compliant shield pad 371 contacts and is adhered to ground shield terminal walls of the channel shields 340 and 341. Thus, the compliant shield pad 371 spans across and is adhered to two different ground shield terminal walls of two different channel shields 340 and 341 in at least one example. A compliant shield pad that spans across ground shield terminal walls of two different channel shields can help to electrically common potentials among the channel shields. In other cases, channel shield pads can be adhered to only one ground shield terminal wall of one channel shield, and the wafer assembly 300 can also include a one-to-one correspondence between compliant shield pads and ground shield terminal walls in some cases. The wafer assembly 300 can also include a combination of compliant shield pads that span across two different ground shield terminal walls of two different channel shields and other compliant shield pads that are adhered to only a single ground shield terminal wall of one channel shield. The compliant shield pads 370-373 can be secured or otherwise attached to the channel shields 340-348 using adhesives, hot melting or welding, mechanical interferences or interlocking features, or using other means or approaches. The compliant shield pads 370-373 and other conductive compliant shielding materials described herein can also be molded onto or over-molded over surfaces and edges of the channel shields and ground shield terminal walls in other approaches.

The compliant ground strip 380 extends laterally across each of the channel shields 340-348, at a position toward the tip ends of the ground shield terminal walls of the channel shields 340-348, as best shown in FIG. 2C. The compliant ground strip 280 can also be located laterally across the channel shields 340-348, or partly across a subset of the channel shields 340-348, at other locations or positions. The wafer assembly 300 can also include more than one compliant ground strip, such as two or more compliant ground strips that extend across one or more of the channel shields 340-348 at one or more locations or positions. The compliant ground strip 380 can be secured or otherwise attached across the channel shields 340-348 using adhesives, hot melting or welding, mechanical interferences or interlocking features, or using other means or approaches. The compliant shield pads 370-373 and the compliant ground strip 380 also form part of the shielding and grounding network in the connector 10. The compliant shield pads 370-373 and the compliant ground strip 380 are conductive and can electrically couple (i.e., electrically “common”) potentials among the channel shields 340-348.

FIG. 3A illustrates a top-down perspective view of the channel shields 244 and 245 and the compliant shield pads 274-276 of the wafer assembly 200 shown in FIG. 2A, and FIG. 3B illustrates a bottom-up perspective view of the channel shields 244 and 245 and the compliant shield pads 274-276. The channel shield 244 provides a type of shielding channel, referenced as the channel “C” in FIG. 3A. The channel “C” is formed between the channel floor walls and channel sidewalls of the channel shield 244, as described below. Each of the channel shield 245, the other channel shields 240-243 and 246-248 in the wafer assembly 200, and the channel shields 340-348 in the wafer assembly 300 provides a similar type of shielding channel. When the wafer assembly 200 is fully assembled, as depicted in FIG. 2A, the signal terminal conductors 230 and 231 and the power terminal conductor 232 are positioned within and extend along the channel “C” of the channel shield 244. Similarly, the signal terminal conductors 224 and 225 are positioned within and extend along a channel of the channel shield 245. FIGS. 3A and 3B omit all terminal conductors, however, so that the features of the channel shields 244 and 245 and the compliant shield pads 274-276 are visible and not obscured.

The channel shields 244 and 245 shown in FIGS. 3A and 3B are representative examples of the channel shields 240-248 in the wafer assembly 200 and of the channel shields 340-348 in the wafer assembly 300. Each of the channel shields 240-248 and 340-348 includes one or more channel floor walls, one or more channel sidewalls, and one or more ground shield terminal walls, similar to those described below in connection with the channel shields 244 and 245. The channel shield 244 is centrally positioned in the wafer assembly 200 and is relatively larger (e.g., wider) than the channel shield 245 and other channel shields in the wafer assembly 200. Similarly, the channel shield 344 is centrally positioned in the wafer assembly 300 and is relatively larger than the other channel shields in the wafer assembly 300.

Referring among FIGS. 3A and 3B, the channel shield 244 includes a first channel floor wall 401, a first channel sidewall 402, a second channel sidewall 403, a second channel floor wall 404, a third channel sidewall 405, and a fourth channel sidewall 406. Together, the channel floor walls 401 and 404 can be referred to as a channel floor of the channel shield 244. The channel sidewalls 402 and 403 can be referred to as a pair of channel sidewalls of the channel shield 244, and the channel sidewalls 405 and 406 can also be referred to as a pair of channel sidewalls of the channel shield 244. The channel shield 244 includes a bend 411 between the channel floor walls 401 and 404 in the example shown. The channel floor wall 401 extends in a direction and plane that is perpendicular to the channel floor wall 404 in the example shown, with the bend 411 facilitating a 90° angle between the channel floor walls 401 and 404. The channel floor walls 401 and 404 can also extend at other angles between each other. The channel sidewalls 402 and 403 are also separated from the channel sidewalls 405 and 406 at the bend 411.

The channel shield 244 also includes a first ground shield terminal wall 420 and a second ground shield terminal wall 421. The ground shield terminal walls 420 and 421 can be referred to as a pair of ground shield terminal walls, ground shield beams, or ground shield terminals of the wafer assembly 200. The first ground shield terminal wall 420 is an extension of the first channel sidewall 402. The first ground shield terminal wall 420 extends beyond an end edge 410 of the channel floor wall 401. A compliancy notch 412 is formed along an upper edge of the channel shield 244, at a location between the first channel sidewall 402 and the first ground shield terminal wall 420. The second ground shield terminal wall 421 is an extension of the second channel sidewall 403. The second ground shield terminal wall 421 extends beyond an end edge 410 of the channel floor wall 401. A compliancy notch 414 is formed along another upper edge of the channel shield 244, at a location between the second channel sidewall 403 and the second ground shield terminal wall 421. The form and purpose of the compliancy notches 412 and 414 are described in further detail below.

The channel shield 245 includes a first channel floor wall 431, a first channel sidewall 432, a second channel sidewall 433, a second channel floor wall 434, a third channel sidewall 435 (see FIG. 3B), and a fourth channel sidewall 436. Together, the channel floor walls 431 and 434 can be referred to as a channel floor of the channel shield 245. The channel sidewalls 432 and 433 can be referred to as a pair of channel sidewalls of the channel shield 245, and the channel sidewalls 435 and 436 can also be referred to as a pair of channel sidewalls of the channel shield 245. The channel shield 245 includes a bend 441 between the channel floor walls 431 and 434 in the example shown. The channel floor wall 431 extends in a direction and plane that is perpendicular to the channel floor wall 434 in the example shown, with the bend 441 facilitating a 90° angle between the channel floor walls 431 and 434. The channel floor walls 431 and 434 can also extend at other angles between each other. The channel sidewalls 432 and 433 are also separated from the channel sidewalls 435 and 436 at the bend 411.

The channel shield 245 also includes a first ground shield terminal wall 450 and a second ground shield terminal wall 451. The ground shield terminal walls 450 and 451 can also be referred to as a pair of ground shield terminal walls of the wafer assembly 200. The first ground shield terminal wall 450 is an extension of the first channel sidewall 432. The first ground shield terminal wall 450 extends beyond an end edge 440 of the channel floor wall 431. A compliancy notch 442 is formed along an upper edge of the channel shield 245, at a location between the first channel sidewall 432 and the first ground shield terminal wall 450. The second ground shield terminal wall 451 is an extension of the second channel sidewall 433. The second ground shield terminal wall 451 extends beyond an end edge 440 of the channel floor wall 431. A compliancy notch 444 is formed along another upper edge of the channel shield 245, at a location between the second channel sidewall 433 and the ground shield terminal wall 451. The form and purpose of the compliancy notches 442 and 444 are described in further detail below.

The channel shields 244 and 245, among others in the connector 10, form part of the shielding and grounding network for the signal terminals in the connector 10. The ground shield terminal walls 420, 421, 450, 451 of the channel shield 244 are relied upon in place of (e.g., rather than) ground or drain terminal conductors in the connector 10. None of the terminal conductors 220-228 and 230-232 in the wafer assembly 200 nor the terminal conductors 320-328 and 330-332 in the wafer assembly 300 are relied upon as ground, drain, or shield terminal conductors, as may be common in other connectors. Instead, the ground shield terminal walls 420, 421, 450, and 451 provide robust shielding walls and offer better EMI rejection among pairs of signal terminal conductors in the connector 10. These and other aspects of the embodiments are described below.

The compliant shield pads 270-279 are positioned and secured along lower edges of the ground shield terminal walls of the channel shields 240-248 in the wafer assembly 200, as shown in FIG. 2B. The compliant shield pads 370-373, among others, are positioned and secured along upper edges of the ground shield terminal walls of the channel shields 340-348 in the wafer assembly 300, as shown in FIG. 2C. The compliant shield pads 270-279, 370-373, and others in the connector 10, also form part of the shielding and grounding network for the signal terminals in the connector 10. FIGS. 3A and 3B show the compliant shield pads 274-276 secured along lower edges of the ground shield terminal walls 420, 421, 450, and 451 of the channel shields 244 and 245.

As noted above, compliant shield pads in the connector 10 can be embodied as a conductive, elastic, compressible material. As one example, the compliant shield pads 274-276 can be embodied as a polyurethane foam multi-laminate including conductive materials, such as copper, nickel, or other conductive metals or materials or as a hyper-elastic material such as silicone doped with conductive media. The compliant shield pads 270-279 (see FIG. 2B) in the connector 10 are positioned and secured along lower edges of the ground shield terminal walls of the channel shields 240-248 in the wafer assembly 200. Each of the compliant shield pads 270-279 is large enough to fit between ground shield terminal walls of two different channel shields among the channel shields 240-248, in some embodiments. The size, shape, and style of the compliant shield pads 270-279 can vary as compared to that shown in the drawings, however, depending on design considerations and needs.

Referring to FIGS. 3A and 3B, the compliant shield pad 274 is secured along a bottom or lower edge of the ground shield terminal wall 420 of the channel shield 244. Although not visible in FIGS. 3A and 3B, the compliant shield pad 274 can also be secured along an edge of a ground shield terminal wall of the channel shield 243, as shown in FIG. 2B. Thus, the compliant shield pad 274 can be secured or otherwise attached to both of the adjacent channel shields 243 and 244 in the connector 10. The compliant shield pad 274 can electrically couple or common potentials among the channel shields 243 and 244, because the compliant shield pad 274 is conductive. The compliant shield pad 275 is secured along and between the bottom or lower edges of both the ground shield terminal wall 421 of the channel shield 244 and the ground shield terminal wall 450 of the channel shield 245, as shown in FIG. 3B. The compliant shield pad 276 is secured along a bottom or lower edge of the ground shield terminal wall 451. Although not visible in FIGS. 3A and 3B, the compliant shield pad 276 can also be secured along an edge of a ground shield terminal wall of the channel shield 246, as shown in FIG. 2B. Although not shown in FIGS. 3A and 3B, the compliant ground strip 280 extends and is secured laterally across the ground shield terminal walls of all the channel shields 240-248, as best shown in FIGS. 2A and 2B. The compliant ground strip 280 can also help to electrically couple or common potentials among the channel shields 240-248, because the compliant ground strip 280 is conductive.

As noted above, the ground shield terminal walls 420, 421, 450, and 451 of the channel shields 244 and 245 provide robust shielding walls and EMI rejection between pairs of signal terminal conductors in the connector 10. The compliant shield pads 274-276 can further augment and enhance the shielding provided by the ground shield terminal walls 420, 421, 450, and 451. The compliant shield pads 274-276 offer compliancy and a type of “seal” or “line contact” on or over the top surface of a PCB-style tip, for example, when inserted into the connector 10. These and other aspects of the embodiments are described in further detail below.

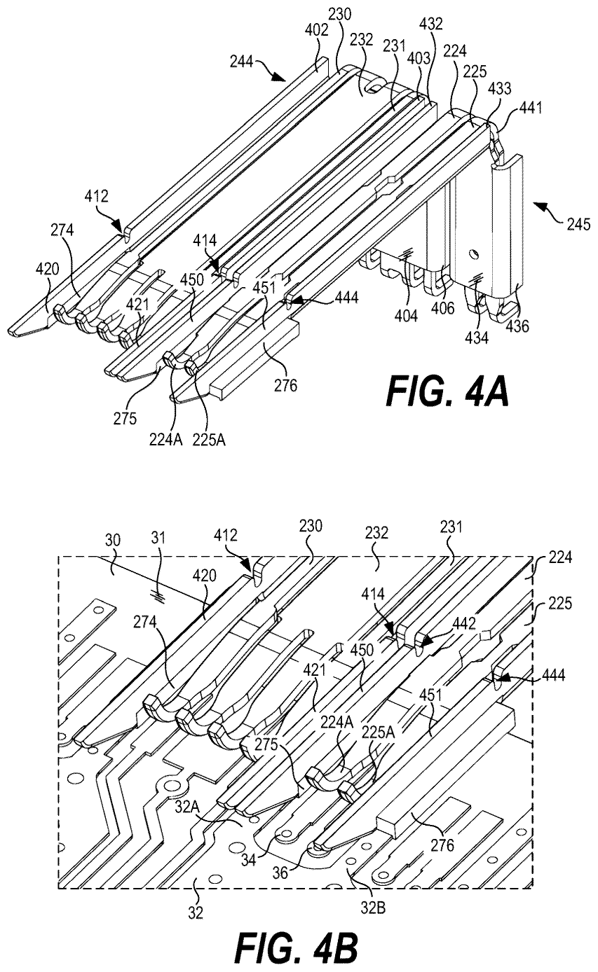

FIG. 4A illustrates a top-down perspective view of the channel shields 244 and 245, terminal conductors 224, 225, and 230-232, and compliant shield pads 274-276 of the wafer assembly 200 shown in FIG. 2A. The signal terminal conductors 230 and 231 and the power terminal conductor 232 are positioned within and extend along the channel “C” (see FIG. 3A) of the channel shield 244. Similarly, the signal terminal conductors 224 and 225 are positioned within and extend along a channel of the channel shield 245.

The tip contacts 224A and 225A of the signal terminal conductors 224 and 225, respectively, are also referenced in FIG. 4A. The tip contacts 224A and 225A are positioned between the ground shield terminal walls 450 and 451 of the channel shield 245. The tip contacts 224A and 225A are also positioned between the compliant shield pads 275 and 276, which are secured along the lower edges of the ground shield terminal walls 450 and 451. Thus, the ground shield terminal walls 450 and 451 and the compliant shield pads 275 and 276 flank both sides of the tip contacts 224A and 225A and provide EMI shielding between the signal terminal conductors 224 and 225 and other terminal conductors in the connector 10. Notably, the signal terminal conductors 224 and 225 are shielded by the pair of channel sidewalls 432 and 433 of the channel shield 245, along the channel “C” (see FIG. 3A) of the channel shield 245. Further, the tip contacts 224A and 225A of the signal terminal conductors 224 and 225 are shielded by the ground shield terminal walls 450 and 451 of the channel shield 245, and the compliant shield pads 275 and 276, beyond the end edge 440 (see FIGS. 3A and 3B) of the channel shield 245.

FIG. 4B illustrates another top-down perspective view of the channel shields 244 and 245, terminal conductors 224 and 225, and the compliant shield pads 274-276 of the wafer assembly 200 shown in FIG. 4A. FIG. 4B also illustrates the board card edge interface 30. The board card edge interface 30 is inserted between the rows 210 and 310 (see FIG. 1B) when inserted into the front port opening 12 of the connector 10. The board card edge interface 30 includes a conductive ground pad or plane 32 formed over a top surface 31 of the board card edge interface 30. The board card edge interface 30 also includes conductive signal contact pads 34 and 36 formed over the top surface 31 of the board card edge interface 30, among other features. The ground plane 32 and signal contact pads 34 and 36 can be embodied as separated pads or regions of a metal layer formed over the top surface 31 of the board card edge interface 30, which is a PCB.

FIG. 4B depicts how the ground shield terminal walls 450 and 451 and compliant shield pads 275 and 276 contact and rest upon exposed surfaces of fingers 32A and 32B of the ground pad or plane 32. FIG. 4B also illustrates how the tip contacts 224A and 225A of the signal terminal conductors 224 and 225, respectively, contact and rest upon exposed surfaces of the signal contact pads 34 and 36. The tip contacts 224A and 225A are positioned between the ground shield terminal walls 450 and 451 of the channel shield 245 over the board card edge interface 30. The tip contacts 224A and 225A are also positioned between the compliant shield pads 275 and 276 over the board card edge interface 30. The tip contacts of the ground shield terminal walls 450 and 451 and the compliant shield pads 275 and 276 contact and rest upon the fingers 32A and 32B of the ground plane 32. The ground shield terminal walls 450 and 451 and the compliant shield pads 275 and 276 flank both sides of the tip contacts 224A and 225A in the configuration shown in FIG. 4B and provide EMI shielding between the signal terminal conductors 224 and 225 and other terminal conductors in the connector 10. The compliant shield pads 275 and 276 are compressible, expandible, and provide good surface contact along the exposed surfaces of the fingers 32A and 32B of the ground plane 32.

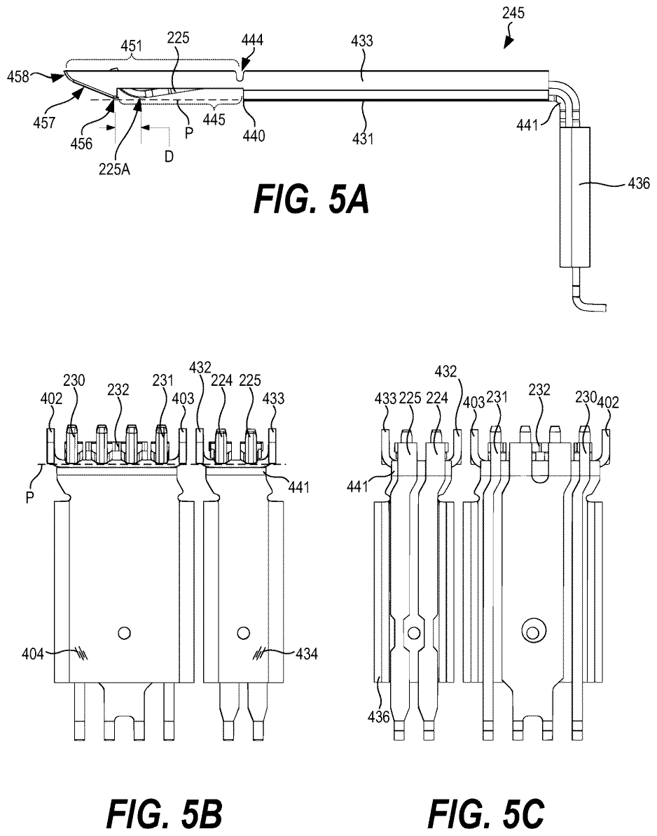

FIG. 5A illustrates a side view, FIG. 5B illustrates a front view, and FIG. 5C illustrates a back view of the channel shields 244 and 245 and the terminal conductors 225, 224, and 230-231 of the wafer assembly 200. Thus, FIGS. 5A-5C depict side, front, and back views of the channel shields 244 and 245 and terminal conductors 225, 224, and 230-231 shown in FIG. 4A. The compliant shield pads 274-276 are omitted from view in FIGS. 5A-5C. The compliancy notch 444 is formed along the upper edge of the channel shield 245, at a location between the second channel sidewall 433 and the ground shield terminal wall 451.

Additional features of the ground shield terminal wall 451 of the channel shield 245 of the wafer assembly 200 are shown in FIG. 5A. FIG. 5A shows a tip contact 456, angled edge 457, and rounded tip end 458 of the ground shield terminal wall 451. FIG. 5A also shows a pad notch 445 of the ground shield terminal wall 451. The compliant shield pad 276 (see FIG. 4A) can be fit and secured into the pad notch 445 of the ground shield terminal wall 451, although it is omitted in FIG. 5A. The shape, size, and features of the ground shield terminal wall 451 are presented as a representative example in the drawings and FIG. 5A. For example, the length of the ground shield terminal wall 451, as measured between the end edge 440 and the rounded tip end 458 of the channel shield 245, can be larger or smaller than that shown. The tip contact 456, angled edge 457, and rounded tip end 458 can also vary in size, shape, and format as compared to that shown. Each of the ground shield terminal walls of the channel shields 240-248 and 340-348 in the connector 10 can be similar to (or the same as) each other in some embodiments. However, in other cases, the wafer assemblies 200 and 300 can include one or more different types (e.g., shapes, sizes, styles, etc.) of ground shield terminal walls.

The wafer assemblies 200 and 300 are designed such that the tips of the terminal conductors and ground shield terminal walls in the rows 210 and 310 (see FIGS. 1A and 1B) will rest upon signal and ground contact pads, respectively, formed on the top and bottom surfaces of the board card edge interface 30, when the board card edge interface 30 is inserted into the front port opening 12 of the connector 10. Thus, the tip contact 456 of the ground shield terminal wall 451 is configured to intersect with a contact tip plane “P” when the board card edge interface 30 is inserted between the rows 210 and 310 of the connector 10. The contact tip plane “P” extends in the same plane as the channel floor wall 431 of the channel shield 245 in the example shown, but the connector 10 can be described such that the contact tip plane “P” is located at other positions.

The tip contact 225A of the signal terminal conductor 225 is also configured to intersect the contact tip plane “P” (i.e., along with the tip contact 456 of the ground shield terminal wall 451) when the board card edge interface 30 is inserted between the rows 210 and 310 of the connector 10. The contact tip plane “P” can be representative of the top surface 31 of the board card edge interface 30. The distance “D” between the tip contact 456 of the ground shield terminal wall 451 and the tip contact 225A of the signal terminal conductor 225 can vary as compared to that shown. The distance “D” can be greater or less than that shown in FIG. 5A, and the distance “D” can be zero or negative in some cases.

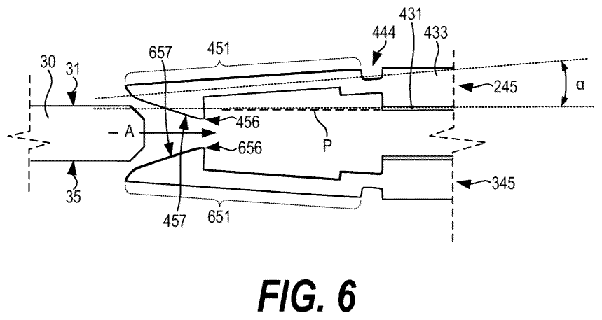

FIG. 6 illustrates another side view of the ground shield terminal wall 451 of the channel shield 245 and the board card edge interface 30. The ground shield terminal wall 451 includes the tip contact 456 and the angled edge 457. The board card edge interface 30 includes top and bottom surfaces 31 and 35. FIG. 6 also illustrates a side view of the channel shield 345 of the lower wafer assembly 300. The channel shield 345 includes a ground shield terminal wall 651 with a tip contact 656 and an angled edge 657.

The board card edge interface 30 is being inserted in the direction “A” and between the ground shield terminal walls 451 and 651 in FIG. 6. Before the board card edge interface 30 is inserted, both the ground shield terminal walls 451 and 651 are angled. For example, the ground shield terminal walls 451 extends at the angle α shown in FIG. 6, with respect to the extension of the channel floor wall 431 of the channel shield 245 and the contact tip plane “P”. The ground shield terminal walls 651 extends at an angle in a similar way. Thus, the channel shields 245 and 345, among others in the connector 10, are designed with ground shield terminal walls that extend at an angle, such as the angle α, as compared to the floor walls and sidewalls of the channel shields.

As the board card edge interface 30 is inserted into the connector 10, the angled edges 457 and 657 will contact the side edge of the board card edge interface 30, and the board card edge interface 30 will push the ground shield terminal walls 451 and 651 apart from each other. The tip contacts 456 and 656 will wipe across the top and bottom surfaces 31 and 35, respectively, of the board card edge interface 30, as it is further inserted further in the direction “A”. When the tip contact 456 contacts the top surface 31, the tip contact 456 will again intersect with the contact tip plane “P”. The compliancy notch 444 is formed along the upper edge of the channel shield 245, at a location between the channel sidewall 433 and the ground shield terminal wall 451. The compliancy notch 444 is designed to permit the bending or rotating of the ground shield terminal wall 451 between the position shown in FIG. 6 and the positions shown in FIGS. 4B and 5A.

As the tip contacts 456 and 656 wipe across the top and bottom surfaces 31 and 35, respectively, of the board card edge interface 30, the compliant shield pad 276 on the ground shield terminal wall 451 (see, e.g., FIG. 4A) can also be compressed to some extent against the top surface 31 of the board card edge interface 30. In a similar way, the compliant shield pad on the ground shield terminal wall 651 can also be compressed to some extent against the bottom surface 35 of the board card edge interface 30.

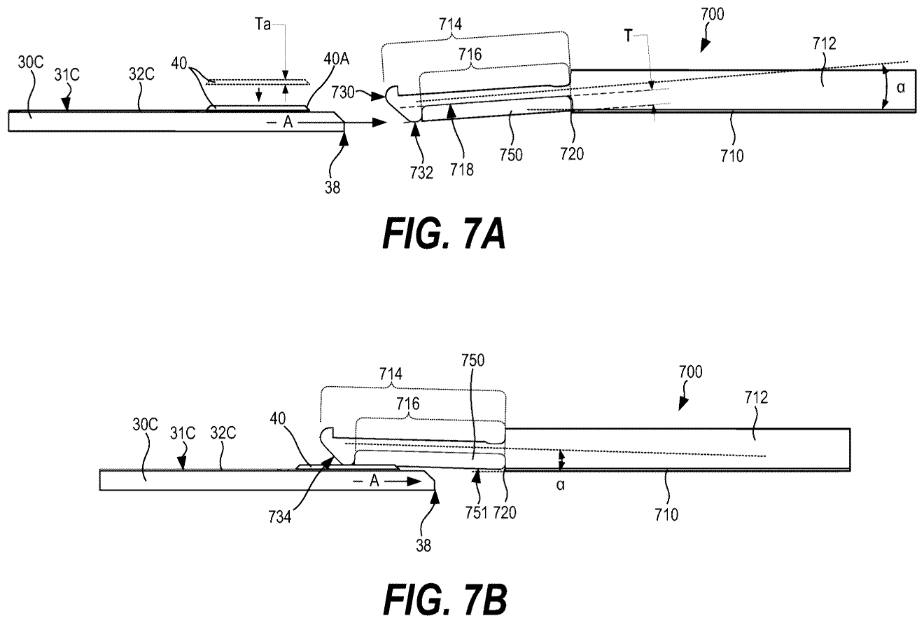

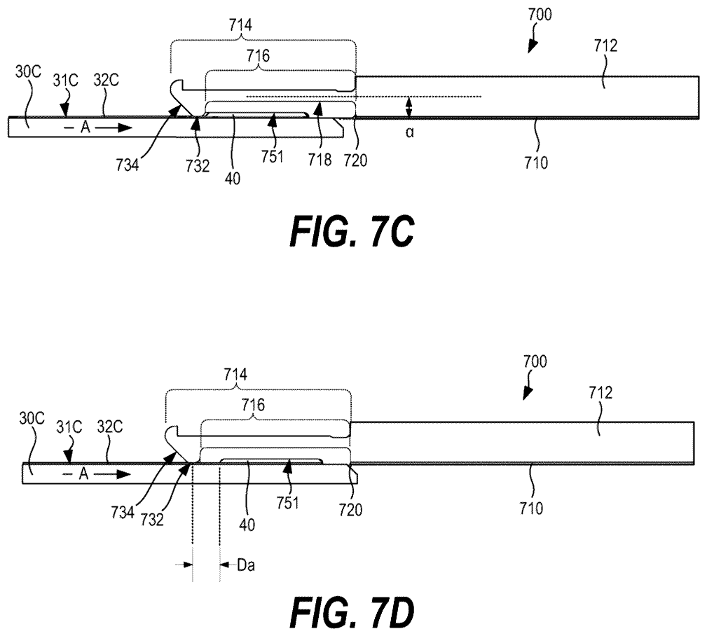

FIG. 7A illustrates a side view of another example channel shield 700, compliant shield pad 750, and board card edge interface 30C. The channel shield 700 is similar to other channel shields described herein, such as the channel shields 244 and 245 described above. Thus, the wafer assemblies 200 and 300 and the connector 10 can incorporate the channel shield 700 according to the embodiments. The channel shield 700 includes a channel floor wall, a pair of channel sidewalls, and a pair of ground shield terminal walls. The channel floor wall 710, channel sidewall 712, and ground shield terminal wall 714 of the channel shield 700 are depicted in FIG. 7A.

The shape, size, and features of the ground shield terminal wall 714 are presented as a representative example in FIG. 7A. The shape, size, and features of the ground shield terminal wall 714 can vary as compared to that shown. It should also be appreciated that the channel shield 700 includes a pair of ground shield terminal walls, each similar to the ground shield terminal wall 714 shown in FIG. 7A. The length of the ground shield terminal wall 714, as measured between the end edge 720 of the channel floor wall 710 and the rounded tip end 730 of the ground shield terminal wall 714, can be larger or smaller than that shown. The tip contact 732, angled edge 734, and rounded tip end 730 of the ground shield terminal wall 714 can also vary in size, shape, and format as compared to that shown.

The ground shield terminal wall 714 includes a pad notch 716. The pad notch 716 extends along a length of the ground shield terminal wall 714. In the example shown, the pad notch 716 extends between the end edge 720 of the channel floor wall 710 and the tip contact 732 of the ground shield terminal wall 714. The pad notch 716 is defined in part by an upper notch edge 718. A compliant shield pad 750 is positioned in the pad notch 716 of the ground shield terminal wall 714. The compliant shield pad 750 contacts and is secured or otherwise adhered to the upper notch edge 718, among other edges and surfaces of the pad notch 716.

The compliant shield pad 750 is similar to the compliant shield pads 274-276 shown in FIGS. 3A, 3B, 4A, and 4B. The compliant shield pad 750 can be secured in the pad notch 716 of the ground shield terminal wall 714 and also in another pad notch of another channel shield. Thus, the compliant shield pad 750 can contact both the ground shield terminal wall 714 of the channel shield 700 and the ground shield terminal wall of another channel shield in a wafer assembly, similar to the way that each of the compliant shield pads 274-276 shown in FIGS. 3A, 3B, 4A, and 4B contacts ground shield terminal walls of two different channel shields.

The compliant shield pad 750 can be embodied as a type of elastic, expandible, and compressible material. The compliant shield pad 750 can also be conductive, in addition to being expandible and compressible. As one example, the compliant shield pad 750 can be embodied as a polyurethane foam multi-laminate including conductive materials, such as copper, nickel, or other conductive metals or materials. The compliant shield pad 750 can be embodied as the P-SHIELD® brand PS-1323, PS-1768, or similar conductive foam, foam tape, or foam sheet manufactured by Polymer Science, Inc. of Monticello, Indiana, although other suitable types of conductive elastomeric or foam materials can be relied upon. As another example, the compliant shield pad 750 can be embodied as a hyper-elastic material, such as silicone doped with conductive media, including the CHO-SEAL 1215 material of Parker Hannifin Corporation.

The size of the compliant shield pad 750 can vary among the implementations. The compliant shield pad 750 has a thickness “T.” The thickness “T” of the compliant shield pad 750 can be measured between the upper notch edge 718 and the tip contact 732 of the ground shield terminal wall 714. More particularly, the thickness “T” of the compliant shield pad 750 is measured, starting from the upper notch edge 718 and extending orthogonally away from the upper notch edge 718, to a line or plane that intersects with the tip contact 732. In the example shown in FIG. 7A, the thickness “T” of the compliant shield pad 750 is substantially the same as or equal to the distance between the upper notch edge 718 and the tip contact 732, measured orthogonally from the upper notch edge 718. The thickness “T” can vary as compared to that shown, however. In other cases, the thickness “T” is less than the distance between the upper notch edge 718 and the tip contact 732. In that case, the compliant shield pad 750 may be positioned within the pad notch 716 but also recessed within the pad notch 716.

FIG. 7A also illustrates a board card edge interface 30C having a top surface 31C. The board card edge interface 30C includes a conductive ground pad 32C formed over the top surface 31C of the board card edge interface 30C, among other conductive pads and traces on the board card edge interface 30C. The conductive ground pad 32C can be metal layer contact pad formed over the top surface 31C of the board card edge interface 30C, which is a PCB. The conductive ground pad 32C shown in FIG. 7A is similar to the fingers 32A and 32B of the ground pad 32 of the board card edge interface 30 shown in FIG. 4B. The tip contact 732 of the ground shield terminal wall 714 will contact and rest upon the conductive ground pad 32C when the board card edge interface 30C and the channel shield 700 are mated with each other, as shown in FIGS. 7B-7C.

The board card edge interface 30C includes a snap actuator 40 (also “actuator 40”) in the example shown. The actuator 40 is positioned over a portion of the conductive ground pad 32C, towards or near a leading edge 38 of the board card edge interface 30C. The actuator 40 can be formed from a conductive material and is electrically coupled to the conductive ground pad 32C. The actuator 40 can be formed from copper or another conductive metal and may be plated with one or more plating metals, such as gold, silver, nickel, tin, or other plating metals. The actuator 40 can be embossed or otherwise formed as part of the board card edge interface 30C, during manufacture of the board card edge interface 30C, or the actuator 40 can be formed separately from the board card edge interface 30C and positioned on the conductive ground pad 32C after the board card edge interface 30C is manufactured. The actuator 40 can include chamfered end edges, such as the chamfered end edge 40A shown in FIG. 7A. The chamfered end edge 40A can help the tip contact 732 of the ground shield terminal wall 714 to rise and wipe up over the top surface of the actuator 40.

The actuator 40, and other actuators over the board card edge interface 30C, can also be positioned at different locations over the board card edge interface 30C. For example, the actuator 40 can extend laterally to, or be repositioned next to, the leading edge 38 of the board card edge interface 30C. Any number of actuators 40 can be positioned over conductive pads of the board card edge interface 30C, such as over one or more conductive ground pads of the board card edge interface 30C. It is not necessary to include an actuator 40 over each conductive ground pad of the board card edge interface 30C, however, and the board card edge interface 30C can include a combination of conductive ground pads with and without actuators 40. One or more actuators similar to the actuator 40 can also be positioned over signal contact pads in some cases. The thickness “Ta” of the actuator 40 can also vary among the embodiments. The thickness “Ta” can range from about 0.05 mm to about 2.5 mm, for example, and all thicknesses in increments of 0.01 mm between 0.05 mm to 2.5 mm, inclusive, are within the scope of the embodiments. The board card edge interface 30C can also include a combination of actuators having different thicknesses. In other implementations, the board card edge interface 30C can omit or be free from any snap actuators, and the channel shields and ground shield terminal walls described herein can be interfaced with board card edge interfaces without the use of snap actuators in some cases.

The board card edge interface 30C can be interfaced with the channel shield 700 by moving the board card edge interface 30C in the direction “A”. More particularly, as the board card edge interface 30C is moved in the direction “A,” the angled edge 734 of the ground shield terminal wall 714 will contact the leading edge 38 of the board card edge interface 30C. As the board card edge interface 30C is moved further in the direction “A,” the ground shield terminal wall 714 will deflect up, and the tip contact 732 will wipe over the leading edge 38, over the top surface 31C, and over the actuator 40 of the board card edge interface 30C.

As compared to FIG. 7A, FIG. 7B illustrates movement of the board card edge interface 30C in the direction “A,” along with the deflection of the ground shield terminal wall 714 up and over the top surface 31C of the board card edge interface 30C. Before the board card edge interface 30C is moved, the ground shield terminal wall 714 extends at the angle α shown in FIG. 7A, with respect to the extension of the channel floor wall 710 of the channel shield 700. In FIG. 7A, the angle α is a closed angle, such that extension of the ground shield terminal wall 714 intersects with a plane in which the channel floor wall 710 extends, and the tip contact 732 is below the channel floor wall 710 of the channel shield 700. In FIG. 7B, however, the angle α is an open angle, and the tip contact 732 is above the channel floor wall 710 of the channel shield 700. The angle α is an open angle due to the actuator 40 deflecting the ground shield terminal wall 714 upwards. Thus, in FIG. 7B, the ground shield terminal wall 714 does not intersect with the plane in which the channel floor wall 710 extends.

FIG. 7B also illustrates how the tip contact 732 of the ground shield terminal wall 714 wipes up and over the actuator 40 of the board card edge interface 30C, as the board card edge interface 30C is moved in the direction “A.” FIG. 7B illustrates the tip contact 732 positioned over the actuator 40. The actuator 40 helps to create (and expand) the open angle α. The actuator 40 also helps to avoid contact and shear forces between the lower surface 751 of the compliant shield pad 750 and the top surface 31C of the board card edge interface 30C. As shown in FIG. 7B, a clearance exists between the top surface 31C of the board card edge interface 30C and the lower surface 751 of the compliant shield pad 750. The clearance results from the mechanical interference between the tip contact 732 and the actuator 40, which is raised up from the top surface 31C and results in the ground shield terminal wall 714 being deflected further up and away from the top surface 31C of the board card edge interface 30C. The actuator 40 can thus help to avoid contact and shear forces between the lower surface 751 of the compliant shield pad 750 and the top surface 31C of the board card edge interface 30C. In that way, the actuator 40 also helps to preserve the lower surface 751 of the compliant shield pad 750 and avoid rips, tears, and other damage to the lower surface 751.

FIG. 7C illustrates the board card edge interface 30C moved even further in the direction “A,” as compared to FIG. 7B. In FIG. 7C, the tip contact 732 has wiped and snapped completely over the snap actuator 40. Thus, the tip contact 732 contacts the top surface of the conductive ground pad 32C rather than the top surface of the snap actuator 40 in FIG. 7C. The angle α can be zero or substantially zero in the arrangement shown in FIG. 7C. As the tip contact 732 drops down from the top of the actuator 40 to the conductive ground pad 32C, the lower surface 751 of the compliant shield pad 750 also drops down upon the top of the actuator 40. The compliant shield pad 750 is compressed in part between the top surface of the actuator 40 and the upper notch edge 718 in the example shown. The actuator 40 helps to ensure sufficient and consistent electrical contact between the compliant shield pad 750 and the top surface of the actuator 40. The “snap over” effect between the tip contact 732 and the actuator 40 helps to avoid damage to the lower surface 751 of the compliant shield pad 750 and also ensures electrical contact between them.

FIG. 7D illustrates the board card edge interface 30C moved even further in the direction “A,” as compared to FIG. 7C. The actuator 40 is positioned in the relative center of the pad notch 716 and the compliant shield pad 750 in the example depicted. The compliant shield pad 750 is also positioned over and contacts both the top of the actuator 40 and the conductive ground pad 32C. In other designs, depending on the thickness of the compliant shield pad 750, the compliant shield pad 750 can contact only the top of the actuator 40 and not the conductive ground pad 32C. The distance “Da” between the tip contact 732 of the ground shield terminal wall 714 and the back edge of the actuator 40 can vary among the embodiments. The distance “Da” can range from about 0.05 mm to about 6 mm or more, for example, and distances in increments of 0.01 mm between 0.05 mm to 6 mm, inclusive, are within the scope of the embodiments.

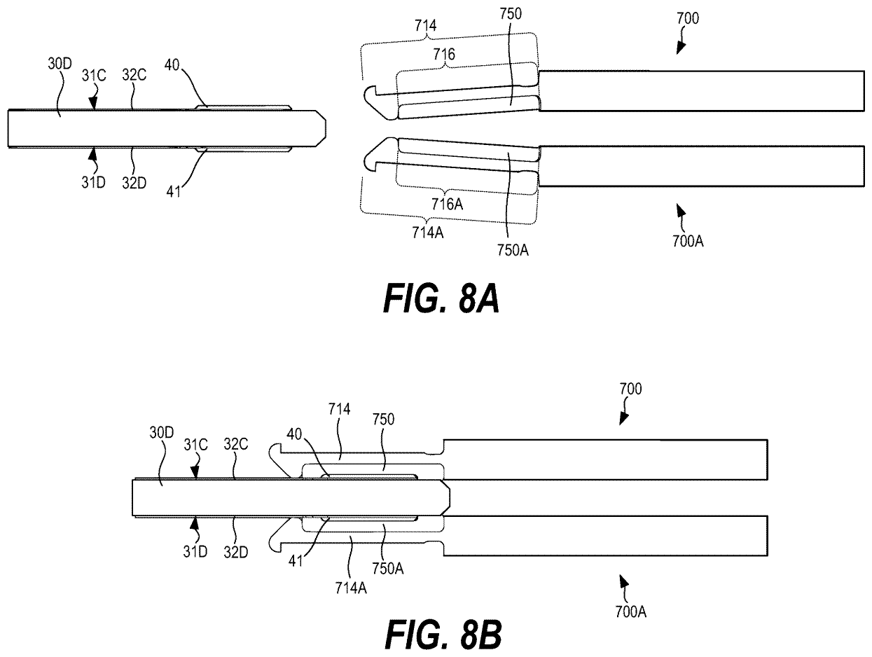

FIG. 8A illustrates a side view of example channel shields 700 and 700A, compliant shield pads 750 and 750A, and a board card edge interface 30D. The channel shield 700A is similar to the channel shield 700 but is positioned in a different wafer assembly. The channel shield 700 can be positioned in the wafer assembly 200 shown in FIG. 2A, for example, and the channel shield 700A can be positioned in the wafer assembly 300. The channel shield 700A includes a ground shield terminal wall 714A with a pad notch 716A. A compliant shield pad 750A is positioned in the pad notch 716A.

The board card edge interface 30D in FIG. 8A is similar to the board card edge interface 30C in FIG. 7A, but the board card edge interface 30D includes a dual-sided edge interface. Thus, the board card edge interface 30D includes a conductive ground pad 32D formed over the bottom surface 31D of the board card edge interface 30D. The board card edge interface 30D also includes both the snap actuator 40 over the conductive ground pad 32C and another snap actuator 41 over the conductive ground pad 32D.

FIG. 8B illustrates another arrangement of the channel shields 700 and 700A, compliant shield pads 750 and 750A, and the board card edge interface 30D shown in FIG. 8A. More particularly, FIG. 8B shows the board card edge interface 30D after being inserted between the channel shields 700 and 700A, as if it were inserted into the front port opening 12 of the connector 10 shown in FIG. 1A, for example. The actuator 40 protects the compliant shield pad 750 from sheer forces as the ground shield terminal wall 714 wipes over the top surface 31C of the board card edge interface 30D. In a similar way, the actuator 41 protects the compliant shield pad 750A from sheer forces as the ground shield terminal wall 714A wipes over the bottom surface 31D of the board card edge interface 30D.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing; and
a wafer assembly positioned in the housing, the wafer assembly comprising a channel shield and a pair of signal terminals that extend along a channel of the channel shield, the channel shield comprising a pair of ground shield terminal walls, wherein:
contact tip surfaces of the pair of signal terminals and of the pair of ground shield terminal walls are configured to intersect a single contact tip plane when a board card edge interface is inserted into the housing.

2. The connector according to claim 1, wherein:
the channel shield further comprises a channel floor wall and a pair of channel sidewalls; and
the channel of the channel shield extends between the pair of channel sidewalls and over the channel floor.

3. The connector according to claim 2, wherein the pair of ground shield terminal walls of the channel shield extend beyond an end edge of the channel floor wall.

4. The connector according to claim 1, further comprising a wafer molding insert that secures the pair of signal terminals to the channel shield and separates the pair of signal terminals from the channel shield.

5. The connector according to claim 1, further comprising a conductive compliant shield pad secured to a ground shield terminal wall among the pair of ground shield terminal walls, wherein the conductive compliant shield pad comprises a conductive foam pad.

6. The connector according to claim 1, further comprising a conductive compliant ground strip secured across the pair of ground shield terminal walls, wherein the conductive compliant ground strip comprises a conductive foam strip.

7. The connector according to claim 1, wherein the channel shield comprises a compliancy notch positioned between a ground shield terminal wall among the pair of ground shield terminal walls and a channel sidewall of the channel shield.

8. A connector, comprising:
a housing comprising a slot for insertion of a board card edge interface; and
a wafer assembly positioned in the housing, the wafer assembly comprising:
a channel shield;
a signal terminal that extends along a channel of the channel shield; and
a compliant shield pad, wherein:
the channel shield comprises a channel floor wall, a channel sidewall, and a ground shield terminal wall that extends from one end of the channel sidewall beyond an end edge of the channel floor wall,
the ground shield terminal wall comprises a pad notch that extends along a length of the ground shield terminal wall, and
the compliant shield pad is secured in the pad notch of the ground shield terminal wall.

9. The connector of claim 8, wherein the ground shield terminal wall comprises a tip contact and an angled edge at a distal end of the ground shield terminal wall.

10. The connector of claim 9, wherein the pad notch extends between the end edge of the channel floor wall and the tip contact.

11. The connector of claim 10, wherein the compliant shield pad is secured and electrically coupled to an upper notch edge of the pad notch.

12. The connector of claim 11, wherein a thickness of the compliant shield pad is substantially equal to a distance between the upper notch edge and the tip contact of the ground shield terminal wall, measured orthogonally from the upper notch edge.

13. The connector of claim 11, wherein a thickness of the compliant shield pad is less than a distance between the upper notch edge and the tip contact of the ground shield terminal wall, measured orthogonally from the upper notch edge.

14. A connector interface, comprising:
a printed circuit board (PCB) having a board card edge interface, the board card edge interface comprising a ground pad and a conductive snap actuator positioned over a portion of the ground pad; and
a connector, the connector comprising a housing having a front port opening for insertion of the board card edge interface and a wafer assembly positioned in the housing, the wafer assembly comprising:
a channel shield;
a signal terminal that extends along a channel of the channel shield; and
a compliant shield pad, wherein:
the channel shield comprises a channel floor wall, a channel sidewall, and a ground shield terminal wall that extends from one end of the channel sidewall beyond an end edge of the channel floor wall,
the ground shield terminal wall comprises a pad notch that extends along a length of the ground shield terminal wall, and
the compliant shield pad is secured in the pad notch of the ground shield terminal wall.

15. The connector of claim 14, wherein, before the board card edge interface is inserted into the front port opening of the connector, the ground shield terminal wall extends at a closed angle with respect to the channel floor wall.

16. The connector of claim 14, wherein the ground shield terminal wall comprises a tip contact and an angled edge at a distal end of the ground shield terminal wall.

17. The connector of claim 16, wherein, when the board card edge interface is inserted into the front port opening of the connector:
the tip contact of the ground shield terminal wall wipes up and over a top surface of the conductive snap actuator; and
the ground shield terminal wall extends at an open angle with respect to the channel floor wall.

18. The connector of claim 16, wherein, when the board card edge interface is inserted into the front port opening of the connector:
the tip contact of the ground shield terminal wall wipes up and onto a top surface of the conductive snap actuator; and
a clearance exists between the a top surface of the board card edge interface and a lower surface of the compliant shield pad.

19. The connector of claim 16, wherein, when the board card edge interface is fully inserted into the front port opening of the connector:
the tip contact of the ground shield terminal wall contacts the ground pad; and
a lower surface of the compliant shield pad contacts a top surface of the conductive snap actuator.
